(19) United States
(12) Patent Application Publication
(10) Pub. No.: US 2013/0061016 A1
(43) Pub. Date: Mar. 7, 2013

(54) VERSATILE DATA PROCESSOR EMBEDDED IN A MEMORY CONTROLLER

(71) Applicants: Ignazio Antonino Urzi, Voreppe (FR); Nicolas Graciannette, St. Nizier due Moucherotte (FR)

(72) Inventors: Ignazio Antonino Urzi, Voreppe (FR); Nicolas Graciannette, St. Nizier due Moucherotte (FR)

(73) Assignee: STMicroelectronics, (Grenoble2) SAS, Grenoble (FR)

(21) Appl. No.: 13/605,880

(22) Filed: Sep. 6, 2012

(30) Foreign Application Priority Data
Sep. 6, 2011 (GB) GB 1115384.8

(51) Int. Cl. G06F 12/00; G06F 12/14

(52) U.S. Cl. 711/163; 711/154; 711/E12.001; 711/E12.091

(57) ABSTRACT

A first engine and a memory access controller are each configured to receive memory operation information in parallel. In response to receiving the memory operation information, the first engine is prepared to perform a function on memory data associated with the memory operation and the memory controller is configured to prepare the memory to cause the memory operation to be performed.

### PRIORITY CLAIM

The present application claims priority to United Kingdom Patent Application Serial No. 1115384.8 filed Sep. 6, 2011. The content of the above-identified patent document(s) is incorporated herein by reference.

### TECHNICAL FIELD

The present application relates generally to memory systems and, more specifically, to minimizing memory latency when crossing a security engine.

### BACKGROUND

Security (encryption) algorithms integrated with mass storage memory devices such as dynamic random access memories (DRAMs) improved data integrity, but can contribute significantly to memory latency and thus to overall processing latency.

There is, therefore, a need in the art for improved memory used with security engines.

### SUMMARY

A first engine and a memory access controller are each configured to receive memory operation information in parallel. In response to receiving the memory operation information, the first engine is prepared to perform a function on memory data associated with the memory operation and the memory controller is configured to prepare the memory to cause the memory operation to be performed.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate system architectures for network-on-chip access of memories, including an architecture having a versatile data processor embedded in a memory controller and masking memory encryption latency in accordance with various embodiments of the present disclosure;

FIG. 2 diagrammatically illustrates a timeline for a command channel and a data channel for a write operation for a DRAM memory; and

FIG. 3 is a high level block diagrams of a versatile data processor embedded in a memory controller and masking memory encryption latency in accordance with one embodiment of the present disclosure;

FIGS. 4A and 4B are timing and flow diagrams of operation of a versatile data processor embedded in a memory controller mask memory encryption latency during read and write operations, respectively, in accordance with various embodiments of the present disclosure; and

FIG. 5 is a high level block diagram of a versatile data processor embedded in a memory controller and masking memory encryption latency in accordance with an alternative embodiment of the present disclosure.

### DETAILED DESCRIPTION

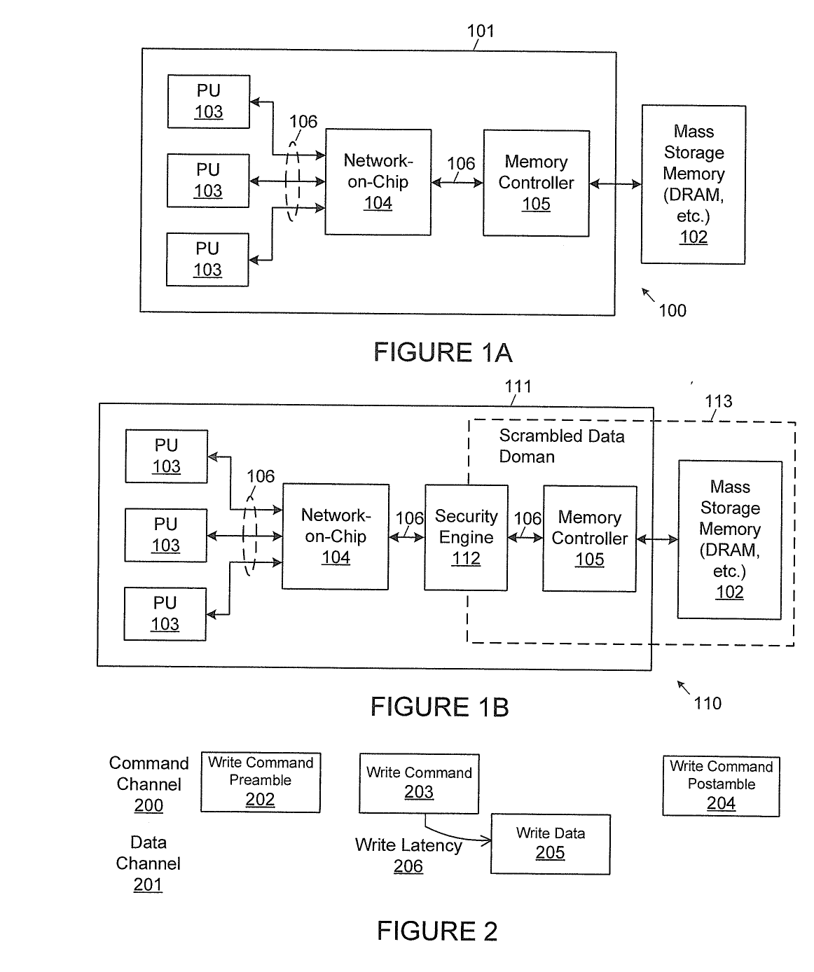

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

The present disclosure relates to an arrangement which may comprise or be coupled to a memory, in particular (but not exclusively) a dynamic random access memory (DRAM). Modern System-on-Chip (SoC) or Network-on-Chip (NoC) designs in application domains may require higher central processing unit (CPU) performance than was previously acceptable. However CPU performance is impacted by memory latency—that is, by the number of clock cycles or the time delay for writing data into the memory and/or the number of clock cycles or the time delay for reading data out of the memory. In particular, the read latency may be different from the write latency.

Still further, some applications require security engines for the encryption and/or decryption of data including, for example, data stored in the memory. A security engine provided in the path between the CPU and the memory may increase the time taken for the read and/or write operations to be completed.

The present disclosure relates to a versatile data processor embedded in a memory controller that masks memory encryption latency. According to one aspect of the present disclosure, an arrangement includes a first engine and a memory controller each configured to receive memory operation information in parallel (concurrently). In response to receiving such information, first engine is prepared to perform a function on memory data associated with the memory operation and memory controller prepares the memory to cause the memory operation to be performed.

FIGS. 1A and 1B illustrate system architectures for network-on-chip access of memories, including an architecture having a versatile data processor embedded in a memory controller and masking memory encryption latency in accordance with various embodiments of the present disclosure. The systems 100 and 110 involve application domains such as High Definition Television (HDTV) or 3-Dimensional Television (3DTV), mobile and multimedia applications, and may be implemented within video receivers or set-top boxes, smart phones, or the like. The architecture 100 in FIG. 1A comprises a system-on-chip (SoC) integrated circuit (IC) 101 and a memory 102. The SoC IC 101 comprises a plurality of processing units (PU) 103, which may be central processing units (CPUs), programmable microcontrollers, and/or any other suitable processing units. The processing units 103 are responsible for the data computing and/or data processing, and optionally also for some degree of system control and/or high level control over system communication with external devices. The processing units 103 may, for example, issue read and/or write requests to the memory 102, which may be any suitable memory including, for example, a mass storage device. In one embodiment, the memory 102 is a DRAM, although the memory may, of course, be any other suitable type of memory. Some embodiments may include a delay between the read/write request (or “command”) and completion of the responsive data access, which may involve either data being written to the memory or data being read from the memory. This delay is or includes the write or read latency, which is the delay between the memory controller 105 requesting that the memory 102 access a particular address and the data being written into the memory 102 (write latency) or the data being output by the memory 102 (read latency).

Each processing unit 103 is arranged to communicate with the memory 102 via a network-on-chip 104 and a memory controller 105. A processing unit 103 sends requests to the memory 102 via the network-on-chip 104 and receives responses from the memory 102 again via the network-on-chip 104. The network-on-chip 104 is arranged to communicate with the memory 102 via the memory controller 105. The network-on-chip 104 provides a routing function, while the memory controller 105 is arranged to control the storage (writing) of data to and/or retrieval (reading) of data from the memory 102. The communication channel 106 between the processing units 103 and the memory controller 105 can be considered to be between the processing units 103 and the network-on-chip 104, and between the network-on-chip 104 and the memory controller 105. The memory 102 contains data that is shared by the processing units 103.

As shown schematically, the processing units 103, network-on-chip 104 and memory controller 105 are provided in the SoC IC 101, with the memory 102 external to the SoC IC. However, it should be appreciated that embodiments may have memory itself as part of the SoC IC 101.

FIG. 1B depicts a system architecture 110 similar to that of FIG. 1A and includes many of the same functional units (denoted by like reference characters), but with a security engine 111 also incorporated. For example, if the memory 102 is located externally to the SoC IC 111, the memory may be regarded as being a security risk for sensitive data. Accordingly, a security engine 112 is provided in the communication channel 106 and is responsible for data scrambling and unscrambling (e.g., encryption and decryption). The security engine 112 is provided between the network-on-chip 104 and the memory controller 105 and defines a scrambled data domain 113 that comprises the memory controller 105 and the mass storage memory 102, as well as the security engine 112. The security engine 112 will scramble data received from the network-on-chip 104 before forwarding that data to the memory controller; likewise, the security engine 112 will descramble the data from the mass storage memory 102 before providing the data to the network-on-chip 104 for use by processing units 103.

In an alternative arrangement, the security engine may be arranged between the NoC 104 and the processors 103.

Because SoCs are consuming more and more data and are requiring higher and higher memory bandwidth, some memories use a protocol with a pipeline command channel to handle these requirements, with several commands per DRAM channel and a data channel. One example of a memory using such a protocol is the DRAM. These channels are provided for example between the memory controller 105 and the memory 102.

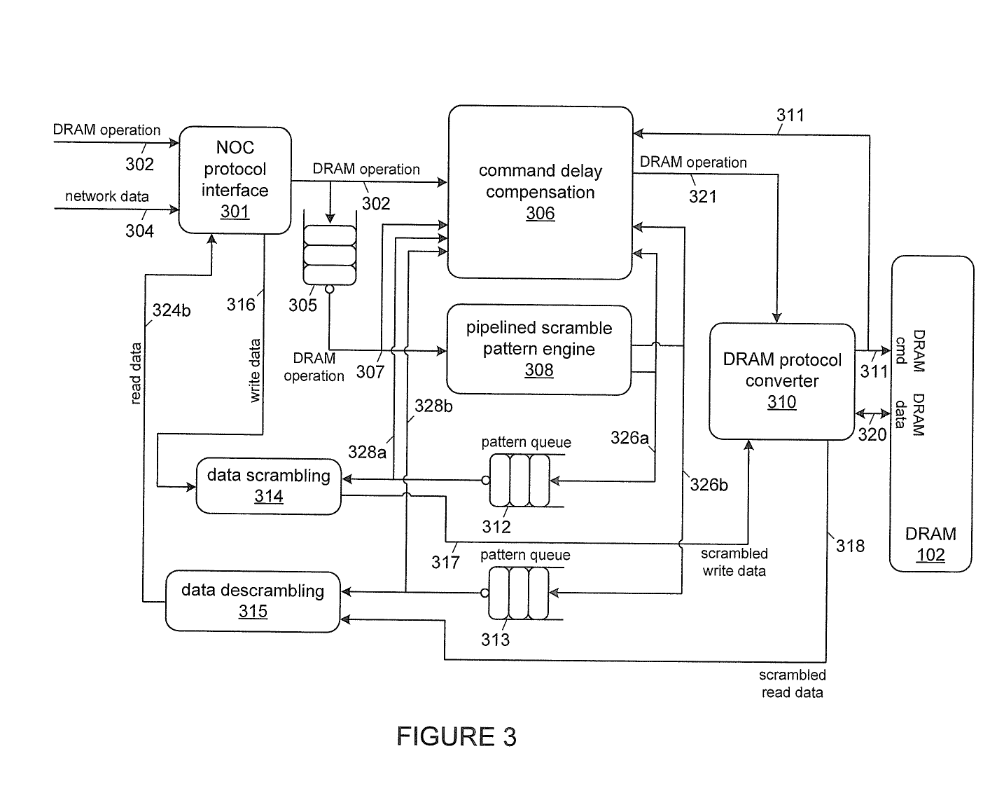

FIG. 2 diagrammatically illustrates a timeline for a command channel and a data channel for a write operation for a DRAM memory. The command channel 200 is provided with several commands per DRAM operation. The data channel 201 is synchronously delayed with respect to the command channel 200. Firstly, a write command preamble 202 is provided on the command channel 200, followed by the write command 203 itself. There is then a delay on the command channel 200 followed by the write command post-amble 204. On the data channel 201, the write data 205 is provided in response to the write command 203. The write data 205 is delayed with respect to the write command 203, which delay 206 is the write latency.

It will be appreciated that while communications on the command channel and data channel are shown for a write operation, the read operation will have a similar delay between a read command on the command channel and the read data of the data channel. Thus, the delays between the command and data channels are commonly known as the write and read latencies, respectively.

The preamble and post-amble commands are used in at least some DRAMs, although those skilled in the art will appreciate that alternative memories may not require the preamble and/or post-amble commands or may have one or more different commands.

With the architecture of FIG. 1B, a delay will be associated with each of the network-on-chip 104, the security engine 112 and the memory controller 105, and cumulative delays may affect the DRAM access time. These cumulative delays will adversely affect the performance of the system-on-chip 111.

In some scenarios, flexibility and/or scalability requirements and industrial standard protocols often lead to the serialization and functional split of overall processing into multiple processing units. DRAM protocol complexity, with the various read and write latencies, may render placement of the security engine in the path between the DRAM controller and the DRAM itself difficult. For example, the DRAM and the associated controller may be provided in a single functional block while the security engine is implemented by a different block, to provide modularity in the design process. The result is that the DRAM and the associated controller do not need to be changed even when used in different products, and likewise the security engine will not need to be changed. However, this means that the DRAM and the associated controller will need to interact with the security engines via their respective interfaces.

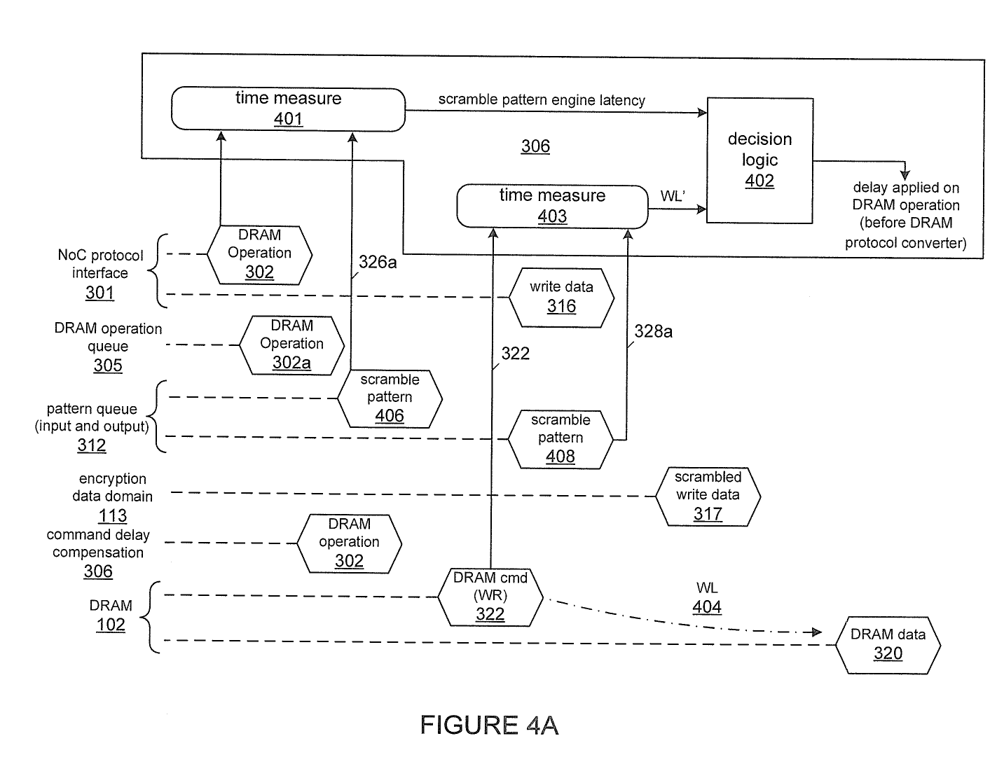

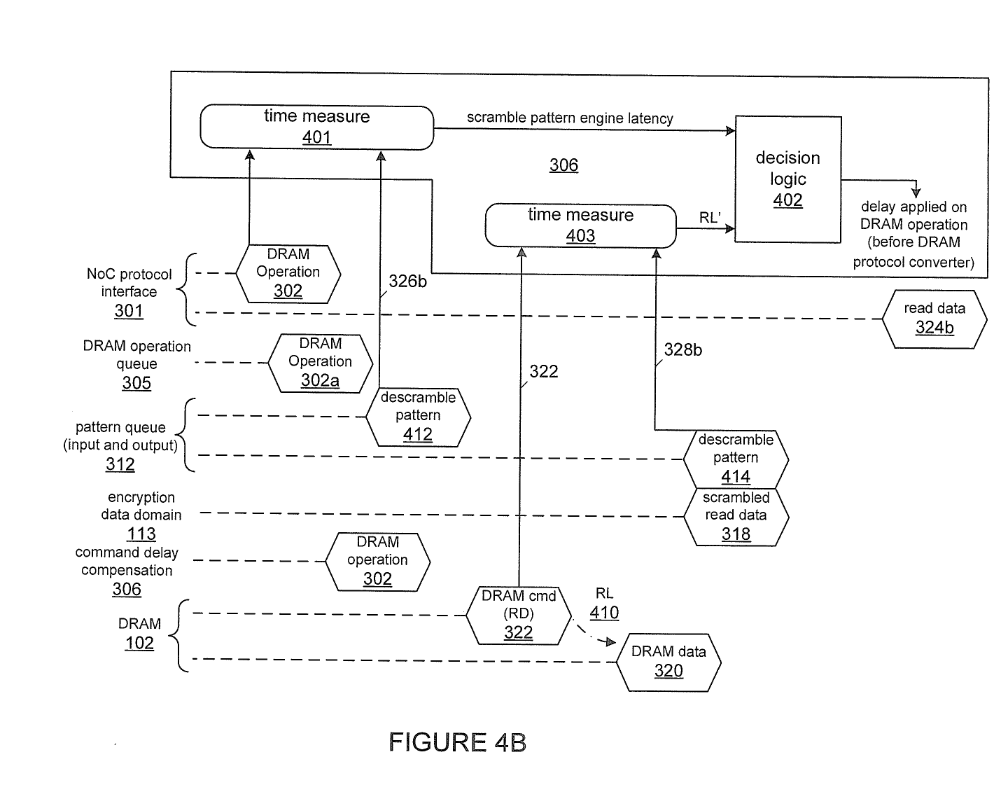

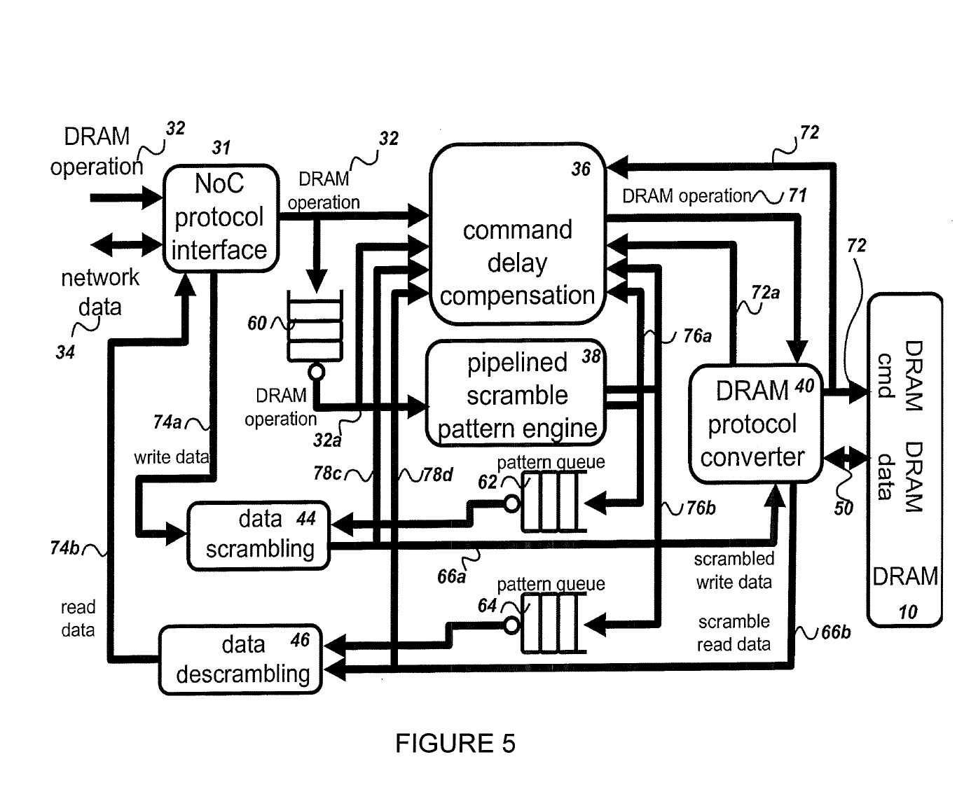

FIGS. 3 and 5 are high level block diagrams of a versatile data processor embedded in a memory controller and masking memory encryption latency in accordance with various embodiments of the present disclosure. FIGS. 4A and 4B are timing and flow diagrams of operation of a versatile data processor embedded in a memory controller mask memory encryption latency during read and write operations, respectively, in accordance with various embodiments of the present disclosure. Some embodiments of the present disclosure use the read and write latencies, in order to hide the security engine processing time. As will be discussed, some embodiments compensate for any delay misalignment to ensure completion of the DRAM access with respect to completion of the data scrambling/unscrambling.

The embodiments described have a DRAM with a DRAM controller and a security engine. However, it should be appreciated that alternative embodiments may be used at other locations in the SoC 111 and/or with other entities other than a memory and its controller and/or the security engine. Such alternatives may be used where the protocol used by interface processing units is managing command and data channels and some other manipulation also needs to be performed on the data. For example, some embodiments may be used where there is data manipulation and a check needs to be made to ascertain the probability that data has been read correctly. Some embodiments may be used where there is redundancy error correction. Some embodiments may be used where there is an application task performed on data.

Some embodiments may be used with a network AXI (Advanced eXtensible Interface) protocol. Of course, other embodiments may be used with other protocols which manage separate command and data channels.

Referring to FIG. 3, the memory 102 is a DRAM. A network-on-chip protocol interface 301 is shown and is part of a network-on-chip 104, not fully depicted in FIG. 3 for simplicity and clarity. The network-on-chip protocol interface 301 receives DRAM operation information 302 (for example a read or write request) and receives and/or outputs network data 304 (i.e., the data to be written to the DRAM or the data read from the DRAM). This network data 304 is received from and/or output to the network-on-chip 104. The network data 304 is sent by the network-on-chip 104 to one or more processor units 103 and/or received by the network-on-chip 104 from one or more processor units 103.

The interface 301 is arranged to provide the DRAM operation information 302 to a command delay compensation block 306 and to a first queue 305. The output 307 of the first queue 305 is a delayed version of the DRAM operation information 302. This output 307 is input to a pipeline scramble pattern engine 308. The DRAM operation information may be a read or write operation. DRAM operation information is received directly by the command delay compensation block 306.

The output of the command delay compensation block 306 is provided to a DRAM protocol converter 310. The DRAM protocol converter 310 is one example of a memory controller 105. The DRAM protocol converter 310 is arranged to receive the DRAM operation information and to output the DRAM command operation 311 to the DRAM 102.

The pipeline scramble pattern engine 308 provides an output to a second queue 312, the output of which is received by a data scrambling block 314, in the case of a write operation. The pipeline scramble engine 308 also provides an output to a third queue 313, the output of which is received by a data descrambling block 315, in the case of a read operation. The pipeline scramble pattern engine 308, the data scrambling block 314 and the data descrambling block 315 (as well as the second and third queues 312 and 313) may be regarded as being the security engine 112. The output provided by the pipeline scramble pattern engine 308 to the data scrambling block and data descrambling block comprises the scrambling and descrambling pattern, respectively. It should be appreciated that the data scrambling block 314 is configured to scramble data to be written to the DRAM 102 while the data descrambling block 315 is configured to descramble data received from the DRAM 102 (i.e., the read data). The DRAM operation information 302 is thus used to get the data scrambling block or data descrambling block ready to carry out the respective operation on the data received by those blocks. The DRAM operation will comprise a read operation or a write operation, in some embodiments.

The NoC protocol interface 301 is configured to provide the write data via path 316 to be written to the DRAM to the data scrambling unit block 314. The data scrambling block 314 scrambles the data using the pattern provided by the pipelined scramble pattern engine 308 via the second pattern queue. The scrambled data is provided via path 317 to the DRAM protocol converter 310. This data 320 is then written to the DRAM.

For read data, the read data 320 is provided by the DRAM 102 to the DRAM protocol converter 310. The read data is then provided via path 318 by the DRAM protocol converter 310 to the data descrambling block 316, which descrambles the read data and provides the descrambled read data to the NoC protocol interface 301.

Read latency and write latency information is fed back from the output of the DRAM protocol converter to the command delay compensation block 306. This feedback may be provided by a data analyzer or snooper or any other suitable mechanism. The read or write latency is or includes the delay between the command channel and the read channel. This information may be determined by snooping the inputs and/or outputs of the DRAM protocol. In some embodiments, the information may alternatively be already known, which may be dependent on configuration. If the information is already known, the information may be stored in the command delay compensation block and/or the protocol convertor.

The function of the command delay compensation block 306 will be described in more detail below.

Referring to FIGS. 4A and 4B, which schematically show how the command delay compensation block 306 is aware of the internal delays, a number of signals are used by the command delay compensation block 306. It should be appreciated that additional signals may be considered in alternative embodiments. In some embodiments, different signals to those shown in FIG. 3 may additionally or alternatively be used by the command delay compensation block 306. In alternative embodiments, fewer than the signals shown may be used by the command delay compensation block. The fewer signals may be the same or different from the signals of the embodiment of FIGS. 3 and 4A-4B.

The first internal information 302 which is used by the command delay compensation block is the DRAM operation information which is received from the output of the NoC protocol interface (not via the queue 305). The second information which is received by the command delay compensation unit 306 is the DRAM command output of the DRAM protocol converter 310, which is indicated by reference character 322. As mentioned previously, the output of the DRAM protocol converter 310 may be snooped and provided to the command delay compensation block 306. Alternatively or additionally, the second information may be provided by an internal signal of the DRAM protocol convertor. This may have the same timing as the DRAM command output or may have a particular timing relationship with the DRAM command output. For example, the internal signal may have an earlier timing or a later timing than the DRAM command output. The internal signal may be output from the DRAM protocol convertor to the command delay compensation unit 306. The third information which is provided is from the input side of the second pattern queue 312, which is identified by reference character 326a. The fourth information which is provided is from the input side of the third queue 313, which is identified by reference character 326b. The fifth information which is provided is from the output side of the second pattern queue 312, identified by reference character 328a. The sixth information which is provided is from the output side of the third queue 313, identified by reference character 328b. The seventh information which is provided is from the output side of the first queue 305. The inputs and/or outputs of the queues may be snooped or monitored in any suitable way.

The command delay compensation block 306 is arranged to provide an output to the DRAM protocol converter. This is the DRAM operation information 302 which comprises the DRAM command channel. The command delay compensation block 306 is able to control the timing of the DRAM operation information and in particular the DRAM commands. In particular, the timing of the provision of the DRAM operation signal to the DRAM protocol converter 310, controls the timing of the DRAM command 322.

In this regard, reference is made to FIG. 4A which shows the timing involved in a write example. The command delay compensation block has a first time measure block 401. This measures a delay between the DRAM operation and the input to the scramble pattern queue. In one embodiment, this is done by measuring the delay between the first information 302 and the third information 326a. This delay is a measure of the scramble pattern latency. This information is provided to a decision block 402.

The command delay compensation block has a second time measure block 403. This measures a delay between the DRAM command at the DRAM 102 and the output of the scramble queue. In one embodiment, this done by measuring the delay between the second information 322 and the fifth information 328a. This delay WL′ provides information relating to a measure of the write latency 404 and the scrambling delay. This information is provided to a decision block 402.

FIG. 4A also provides a time line of the arrangement of FIG. 3. In one embodiment, the following may occur in the listed order:

1. NoC protocol interface receives DRAM operation;
2. The first queue outputs the DRAM operation 302a;
3. Command delay compensation unit receives DRAM operation;
4. Scrambling pattern at input of queue;
5. DRAM command at DRAM;
6a. Write data at NoC protocol interface;
6b. Scramble pattern at output of queue;
7. Scrambled write data output by data scrambling block 314; and
8. Data written to DRAM.
Depending on the latencies, there may by some variation in the relative times of some of the steps. Relative positions of the vents related to the command path with respect to the scrambling path may change. For example, step 5 may occur before step 4 or step 6b may occur before step 5. It should be appreciated that a measure of the write latency can be measured between the DRAM command at the output of the DRAM protocol convertor 310 and the data 320 at the input of the DRAM.

The output of the second time measure block 403 is input to the decision block 402. Thus, the decision block 402 receives information which reflects the latency of the scramble pattern engine and also the DRAM write latency.

The output of the decision block 402 controls the delay applied to the DRAM operation. In particular, the output of the command delay compensation block 306 is used to control when the DRAM protocol converter outputs the DRAM command. This may be controlled by delaying when the DRAM protocol converter 310 receives the DRAM operation from the command delay compensation block 306.

Referring to FIG. 4B, which shows the timing involved in a read example, the first time measure block 401 measures a delay between the DRAM operation and the input to the descramble pattern queue. In one embodiment, this is done by measuring the delay between the first information 302 and the fourth information 326b. This delay is a measure of the scramble pattern latency. This information is provided to the decision block 402.

The second time measure block 403 measures a delay between the DRAM command at the DRAM 102 and the output of the descramble queue. In one embodiment, this is done by measuring the delay between the second information 322 and the sixth information 328b. This delay RL′ provides information about the read latency 410 and the scrambling delay. This information is provided to the decision block 402.

FIG. 4B also provides a time line of the arrangement of FIG. 3 for the read example. In one embodiment, the following may occur in the listed order:

1. NoC protocol interface receives DRAM operation;
2. The first queue outputs the DRAM operation 32a;
3. Command delay compensation unit receives DRAM operation;
4. Descrambling pattern at input of queue;
5. DRAM command at DRAM;
6. DRAM data read from DRAM;
7a. Descramble pattern at output of queue;
7b. Scrambled read data output from DRAM protocol converter; and
8. Read data at NoC protocol interface.
Depending on the latencies, there may by some variation in the relative times of some of the steps as discussed in relation to FIG. 4A. It should be appreciated that the read latency can be measured between the DRAM command at the output of the DRAM protocol convertor 310 and the data 320 at the output of the DRAM.

Referring to FIG. 5, which shows an alternative embodiment similar that in FIG. 3, instead of snooping the output of the second and third queues, the output of the data scrambling unit 314 (see line 328c) and the input to the data descrambling unit 315 (see line 328d) may be used instead. This may be done where the delay through scrambling unit or descrambling unit is known by the decision block. Alternatively or additionally (as shown in FIG. 5), the read and write latencies is generally programmed into the protocol convertor. In some embodiments this may be extracted. This information may be known with respect to the DRAM protocol converter. A link 322a to the command delay compensation unit provides the read and/or write latency. The read and write latencies may be obtained from the DRAM specification. This can be used in combination with scrambling block latency information by the command delay compensation unit. This means in some embodiments that block 403 may be omitted.

In the case of the architecture of FIG. 1B, the time delays can be regarded as N+M+x where N is the delay of the security engine, M is the latency of the memory controller and x is the read/write latency (the delay between the write command and the write data on the output of the controller or the delay between the read command and the read data at the controller).

In some embodiments, the latency may be M+x, where x is used to mask the delay N. Generally x is greater than or equal to N. Where x is not greater than or equal to N, the decision logic will add a delay y to satisfy the requirement, by delaying when the command is issued by the memory controller. x+y will be greater than or equal to N.

The first time measure block 401 is providing a measure of N and the second time measure block 403 is providing a measure of x. The command delay compensation may adjust the delay on the DRAM operation using an iterative algorithm which adjusts the delay and can learn over several DRAM operations. Some embodiments may improve the DRAM access latency of systems having a security engine. The latency required for the scramble pattern computation may be effectively hidden by taking advantage of the intrinsic latency of the DRAM protocol. Embodiments may permit the encryption of sensitive data stored in an external memory. The security engines have a latency associated therewith. The encryption latency can be masked fully or partially due to the latency present in a number of memory protocols supporting for example burst mode operation.

Some embodiments may have the advantage that a modular approach may be made with respect to the memory controller on the one hand and the scrambling engine on the other hand. This may reduce design time and effort.

The embodiments described have the first, second and third queues. One or more of these queues may be dispensed with. In alternative embodiments one or more additional queues may be provided at any suitable location or locations. For example, one or more queues may be associated with the DRAM protocol convertor 40. Some embodiments may even have no queues. In some embodiments, the number and position of the queues may be dependent on a required timing performance for a specific implementation.

The one or more queues may provide synchronization between different blocks. For example the first queue may provide synchronization between for example, one or more of the NoC protocol interface 301, the pipelined scramble pattern engine 308, the data scrambling block 314 and the data descrambling block 315. Similar synchronization may be provided by the second queue between, for example, the scramble pattern engine and the data scrambling block 314. Likewise, similar synchronization may be provided by the third queue between for example, the scramble pattern engine and the data descrambling block 315.

Some embodiments may be used with only one or with more processing units. Some embodiments may be used other than in system on chips. Some embodiments may be in an integrated circuit or partly in an integrated circuit and off chip or completely off chip. Some embodiments may be used in a set of two or more integrated circuits or in two or more modules in a common package. Some embodiments may be used with a different routing mechanism to the NoC routing described. For example, crossbar buses or other interconnects may be used.

The security engine has been described as performing scrambling and descrambling. Other embodiments may additionally or alternatively use other methods of applying security to data.

One or more of the queues may be provided by buffers, FIFOs or any other suitable circuitry. Alternative embodiments may use different references points in order to provide a measure of a particular latency. The command delay compensation block means that some embodiments have the learning capability to measure unknown system delays as well as DRAM latencies.

Some embodiments have the adaptive capability to compensate system delays with respect to DRAM latencies and adjust the DRAM operation execution time to satisfy the operation requirements. While embodiments have been described in relation to a DRAM, it should be appreciated that embodiments may alternatively be used with any other memory.

The described embodiments have been in the context of a security engine with respect to read and write latency. It should be appreciated that alternative embodiments may be used with any other engine with an associated delay.

Although the present disclosure has been described with an exemplary embodiment, various changes and modifications may be suggested to one skilled in the art. It is intended that the present disclosure encompass such changes and modifications as fall within the scope of the appended claims.

1. A system, comprising:
a first engine configured to receive memory operation information and to prepare the first engine to perform a function on memory data associated with the memory operation based on the received memory operation information;
a memory access controller configured to receive the memory operation information concurrently with the first engine and to prepare the memory to perform the memory operation;
a timing control configured to control when the memory access controller receives the memory operation information, wherein the timing control is configured to control when the memory access controller receives the memory operation information so that a delay of the first engine is less than or equal to a delay of the memory.

2. The system according to claim 1, wherein the timing control is configured to control when the memory receives the memory operation information based upon delay information of the memory and delay information of the first engine, wherein at least one of the delay information is dependent on latency.

3. The system according to claim 1, wherein the timing control means is configured to determine delay information from one of a timing difference between the memory access controller outputting the memory operation information and the first engine being ready to perform the function and a timing difference between the memory operation information being received by the system and the first engine being ready to perform the function.

4. The system according to claim 1, wherein the first engine comprises a security engine and the security engine comprises at least one scrambling pattern queue.

5. The system according to claim 4, wherein at least one of an input and an output of the at least one of scrambling pattern queue is used to provide information indicating that the first engine is ready to perform the function.

6. The system according to claim 4, wherein the at least one scrambling pattern queue is configured to receive a scrambling pattern from a scrambling pattern engine.

7. The system according to claim 6, wherein the scrambling pattern is dependent on the memory operation information.

8. A method, comprising:
receiving memory operation information at a first engine configured;
preparing the first engine to perform a function on memory data associated with the memory operation based on the received memory operation information;
receiving the memory operation information at a memory access controller concurrently with the first engine;
preparing a memory to perform the memory operation;
determining when the memory access controller receives the memory operation information; and
controlling when the memory access controller receives the memory operation information so that a delay of the first engine is less than or equal to a delay of the memory.

9. The method according to claim 8, wherein the memory receives the memory operation information based upon delay information of the memory and delay information of the first engine, wherein at least one of the delay information is dependent on latency.

10. The method according to claim 8, further comprising:
determining delay information from one of a timing difference between the memory access controller outputting the memory operation information and the first engine being ready to perform the function and a timing difference between the memory operation information being received by the system and the first engine being ready to perform the function.

11. The method according to claim 8, wherein the first engine comprises a security engine and the security engine comprises at least one scrambling pattern queue.

12. The method according to claim 11, wherein at least one of an input and an output of the at least one of scrambling pattern queue is used to provide information indicating that the first engine is ready to perform the function.

13. The method according to claim 11, wherein the at least one scrambling pattern queue is configured to receive a scrambling pattern from a scrambling pattern engine,

14. The method according to claim 13, wherein the scrambling pattern is dependent on the memory operation information.

15. A system, comprising:
a first engine configured to receive memory operation information requiring a scrambling operation and, based on the received memory operation information, to prepare the first engine to perform a scrambling function on memory data associated with the memory operation;
a memory access controller configured to receive the memory operation information concurrently with the first engine and to prepare a memory to perform the memory operation; and
a timing control configured to control when the memory access controller receives the memory operation information, wherein the timing control means is configured to control when the memory access controller receives the memory operation information so that a delay of the first engine is less than or equal to a delay of the memory.

16. The system according to claim 15, wherein the timing control is configured to control when the memory receives the memory operation information based upon delay information of the memory and delay information of the first engine, wherein at least one of the delay information is dependent on latency.

17. The system according to claim 15, wherein the timing control means is configured to determine delay information from one of a timing difference between the memory access controller outputting the memory operation information and the first engine being ready to perform the function and a timing difference between the memory operation information being received by the system and the first engine being ready to perform the function.

18. The system according to claim 15, wherein the first engine comprises a security engine and the security engine comprises at least one scrambling pattern queue.

19. The system according to claim 18, wherein at least one of an input and an output of the at least one of scrambling pattern queue is used to provide information indicating that the first engine is ready to perform the function.

20. The system according to claim 18, wherein the at least one scrambling pattern queue is configured to receive a scrambling pattern from a scrambling pattern engine.
